(19) United States
(12) Patent Application Publication
(10) Pub. No.: US 2008/0195265 A1
(43) Pub. Date: Aug. 14, 2008

(54) Train Integrity Network System

(75) Inventors: Donald Stephen Searle, Bindoon (AU); Charles Richard Wallace Wilkins, Nedlands (AU)

Correspondence Address: JACOBSON HOLMAN PLLC, 400 SEVENTH STREET N.W., SUITE 600, WASHINGTON, DC, 20004, US

(73) Assignee: STI RAIL PTY LTD, Subiaco, W.A. (AU)

(21) Appl. No.: 11/579,470

(22) PCT Filed: May 3, 2005
(86) PCT No.: PCT/AU2005/000624

§ 371 Date: Jan. 4, 2008

(30) Foreign Application Priority Data
May 3, 2004 (AU) 2004902285

(51) Int. Cl. G06F 17/00

(52) U.S. Cl. 701/19

(57) ABSTRACT

A train integrity network system comprises bogie units which monitor critical parameters relating to the condition of bogie components and the rail track they are travelling on, an onboard server which controls the bogie units and a wireless network which enables communication between the server and the bogie units. Each bogie unit is powered by an electrical generator which utilises the rotation of the bogie wheels and has a processor which compares the critical parameters against defined standards in order to issue alerts to the train driver. The wireless network utilises master/slave base band role switching, has store-and-forward nodes which convey quasi real time data to the server and utilises frequency hopping modes.

### FIELD OF THE INVENTION

This invention relates to computerised real time wireless network communication systems for monitoring rail and other vehicular transport for component failure and other safety aspects.

### BACKGROUND OF THE INVENTION

The prior art in the field of rail transport safety discloses a number of devices designed to monitor the failure of critical components such as wheels, bearings, axles and the rail itself. For example U.S. Pat. No. 6,672,681 teaches a railway axle hub sensor unit for detecting vibrations in vertical and horizontal axial directions and signalling an impending failure and/or a damaged condition whereas U.S. Pat. No. 5,381,692 also uses temperature sensors to signal abnormal bearing temperatures.

U.S. Pat. No. 5,433,111 discloses apparatus and a method for detecting defective conditions in both the train wheels and the rail tracks using a mobile tracking unit to record the location of the latter. Similarly, U.S. Pat. No. 6,435,027, U.S. Pat. No. 6,471,407, U.S. Pat. No. 5,631,426, U.S. Pat. No. 6,378,373 and U.S. Pat. No. 5,022,267 all teach various combinations of motion and temperature sensors to signal component failure and U.S. Pat. No. 6,474,832 teaches a self regulating axle mounted device for generating electrical energy to power such apparatus.

However there are a number of major issues involved in monitoring all the critical components of a train at the same time, especially in long freight trains, and combining the output of many sensors to warn of developing problems before a critical failure. For example running cables throughout trains is not practical as carriages and wagons are regularly shunted into and out of different trains to make up an operating consist. Cabling plugs and sockets, compatibility from operator to operator, age of wagons and access is difficult and labour intensive. Accordingly there is a need for a wireless network which sends data processed at an axle end to a server located in the prime mover where the information is processed against set rules and automatic or manual intervention commands issued.

Further the wireless communications system must have the ability to operate in an ad-hoc environment where the sensor units on the wagon wheels have no prior knowledge of each other but must be automatically configured to cooperate with each other in a particular train consist. Also the system must have built in redundancy, that is, the monitoring system of the server in the locomotive must be ready to act in the case of a critical situation even if signalling from specific units has failed; the failed axle units must be identified and the network automatically re-established to maintain monitoring.

Another major issue is the requirement for a reliable stable power supply for the wheel monitoring and radio networking system, since freight rolling stock do not have power on board. Each wheel unit must have a small generator powered by utilising the rotation of the wheel hub and since the power generated varies with the speed of rotation of the wheel, stable regulation of the electrical energy generated is a critical issue. Finally the system must be able to interact with a range of sensor systems which gather data for transfer to the wheel processing units.

It is also desirable for a train integrity network system (TINS) to perform the following functions:
measuring coupling tension between wagons to enable more efficient loading and train management
monitoring pack components such as sandwich packs, yokes and air supply.
detecting coupling failure between wagons
monitoring wheel slip and braking malfunction
detecting wheel damage, failure and derailment
detecting axle fatigue
monitoring the security of unloading and discharge doors
monitoring wear surfaces
monitoring wheel wear and profile
tracing the cause of steering defects
lighting the side of trains to ensure visibility at rail crossings
tracking location of individual wagons
tracking the consignment of mixed goods
electronic monitoring of interactions with wayside operation systems
warning rail crossing users of train proximity
provision of warning and prevention of train to train and other collision dangers
provision of real time monitoring of railway crossings and rail station crossovers to prevent vehicular and pedestrian accidents
provision of an alternative to conventional signalling methods based on global information systems
detecting and locating track failure using global information systems.

Although developed for use in trains, such integrity network systems have a wide range of potential application in a variety of vehicles such as trams, mining machinery and road trains. The network can also be used to monitor and relay structural integrity and to collect data and security information in a range of applications such as buildings, bridges, engineering infrastructure and public places.

### OBJECT OF THE INVENTION

It is therefore an object of the present invention to provide a train integrity network system (TINS) which has some of the above functions or at least provides a useful alternative to prior art systems.

### STATEMENT OF THE INVENTION

According to the present invention a train integrity network system comprises two or more bogie units which monitor critical parameters relating to the condition of bogie components and the rail track they are travelling on, an onboard server which controls the bogie units and a wireless network which enables communication between the server and the bogie units.

Preferably the bogie units have sensors to monitor the temperature of the wheel hubs of the bogie.

Preferably the bogie units have sensors to monitor the temperature of the wheel perimeters of the bogie.

Preferably the bogie units have motion detectors to monitor movement of the bogie axle in vertical and horizontal directions.

Preferably the bogie units have accelerometers to monitor acceleration of the bogie axle.

Preferably the bogie units have means to measure the speed of rotation of the bogie wheels.

Preferably the bogie units are powered by an electrical generator which utilises the rotation of the bogie wheels.

Preferably the bogie units have a processor which compares the critical parameters against defined standards.

Preferably the bogie units have a wireless transceiver which enables communication with other bogie units and the server.

Preferably the bogie units have a source of illumination.

Preferably the wireless network utilises master/slave base band role switching.

Preferably the wireless network has store-and-forward nodes which convey quasi real time data to the server.

Preferably the wireless network has frequency hopping modes.

Preferably the server can download data to a wayside database.

Preferably the system has a GPS unit to record the location of the train at any time.

Preferably the system has an end-of-train monitoring function.

Preferably the system has a collision avoidance function.

Preferably the system has a level crossing warning function.

Preferably the system transmits a warning signal to vehicles approaching a level crossing which are equipped to receive said signal.

Preferably the system monitors tension and compression in the train wagon couplings.

### BRIEF DESCRIPTION OF THE DRAWINGS

A particular embodiment of the invention is now described by way of example only with reference to the accompanying drawings in which:

FIG. 1 illustrates the general arrangement of the store and forward function of individual bogie units and their master/slave automatic configuration,

FIG. 2 illustrates the overall network architecture of the system,

FIG. 3 illustrates the architecture of a bogie unit,

FIG. 4 shows the sensor circuit board layout of a bogie unit,

FIG. 5 illustrates the server architecture,

FIG. 6 illustrates a TINS network of 4 unit depth and 3 unit width,

FIG. 7 illustrates the TINS network of FIG. 6 during the establishment phase,

FIG. 8 illustrates the basic establishment methodology of the TINS network,

FIG. 9 illustrates the network discovery messaging of the TINS network,

FIG. 10 illustrates the RSSI and wheel number division of time during network discovery,

FIG. 11 illustrates the extension of the network,

FIG. 12 is the network establishment flowchart,

FIG. 13 shows the network establishment frequency use,

FIG. 14 shows the progression of hopping channel with each control frame,

FIG. 15 shows an ideal coverage map for a network of 5 unit depth and 2 unit width,

FIG. 16 is a transmit data flowchart,

FIG. 17 is a receive data flowchart,

FIG. 18 shows the RF section of a bogie unit,

FIG. 19 is a schematic of a bogie unit,

FIG. 20 is a photograph of a bogie unit,

FIG. 21 shows the layout of a bogie unit with remote infrared censor and

FIG. 22 is a schematic of the bogie unit software architecture.

### DETAILED DESCRIPTION OF THE INVENTION

The TINS has two main components, namely, the bogie units which incorporate the wireless communication system, and the onboard server unit. The bogie units monitor in real time various wheel and track factors including rotation, vibration, g-force acceleration and bearing temperature, as well as the causes of differential temperature effects. The information is analysed in a processor in the bogie unit by means of algorithms which have been developed to recognise a range of specific component conditions. If a monitored condition exceeds a predetermined threshold or parameter the processor will generate an alarm which is transmitted via a RF network to the server. The server then notifies the driver via a control console, of the specific exception, including the condition, the position of the bogie in the train consist, the last ten minutes of trend information and a menu of corrective actions to be taken.

The bogie units comprise:
various temperature, motion and acceleration sensors
a microprocessor to analyse signals from the sensors
non volatile memory for data storage
a radio modem for communicating with the on board server and other bogie units
a power generation and regulation system
an external housing
programming software
an antenna and
strobe lighting

The server comprises:
a laptop or other personal computer
three radios and related modems
antennas
a GPS transponder
programming software
a data storage device
and a video compression engine

The bogie units can detect:
a hot axle box
flat and broken wheels
wheel slip and wheel derailment
end-of-train and train handling
brake failure and hot wheels
hunting wheel sets and
track conditions such as corrugations, cracked and broken rails and horizontal and vertical defects.

The core of the TINS is a RF/Digital wireless communications backbone which links the monitoring and processing hardware and software of the bogie units with the server and each other. The units are installed on each end of a bogie and monitor a range of parameters which detect the above conditions. This information is then relayed through the wireless backbone to alert the driver to intervene manually or to trigger an automatic response in critical situations. There is a “heart beat” protocol within the TINS which establishes that the bogie units are on-line and fully operational and reports any that have failed. Accordingly the TINS not only guards against derailments but improves performance and efficiency thus reducing operational costs.

A critical aspect of the TINS is the ability of the bogie units to self-configure, that is when wagons are coupled into a train consist there is no shared information between the units and the server. However, once the consist is assembled and the units power up, they can be either manually or automatically booted so that they start to communicate with each other and within several minutes become united in the one network with the sever to provide whole train integrity. If one of the units fails the adjacent units leap-frog to the next operating unit to maintain the train's “heart beat” which is essential for operational redundancy. Since it has an open architecture, the TINS can also host a range of additional “smart” monitoring and warning systems such as collision avoidance.

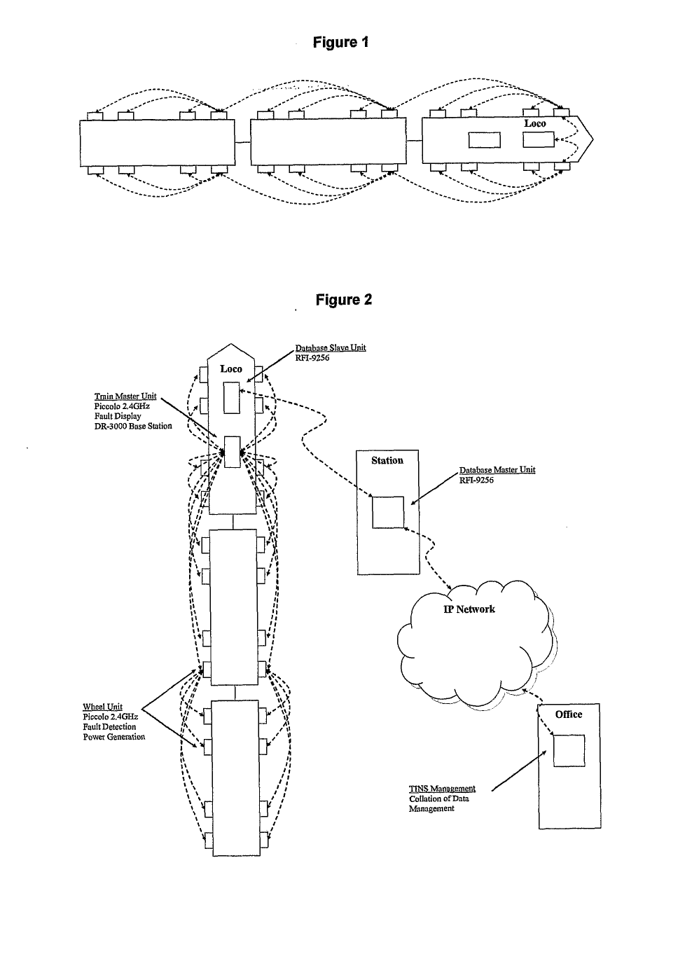

FIGS. 1 and 2 illustrate the overall network architecture between the units, the server, a database slave unit, both located in the loco, a database located in a station and a remote management server. When the train powers up, the server establishes a fully connected network of master, repeater, and slave units. This network then transmits signals generated by the sensors to the server where the data is collated. As the train passes through a station, a radio modem is used to download the data to a wayside database which is connected to a remote management server via an IP network. The station databases provide the statistics for final collation and analysis by the management server.

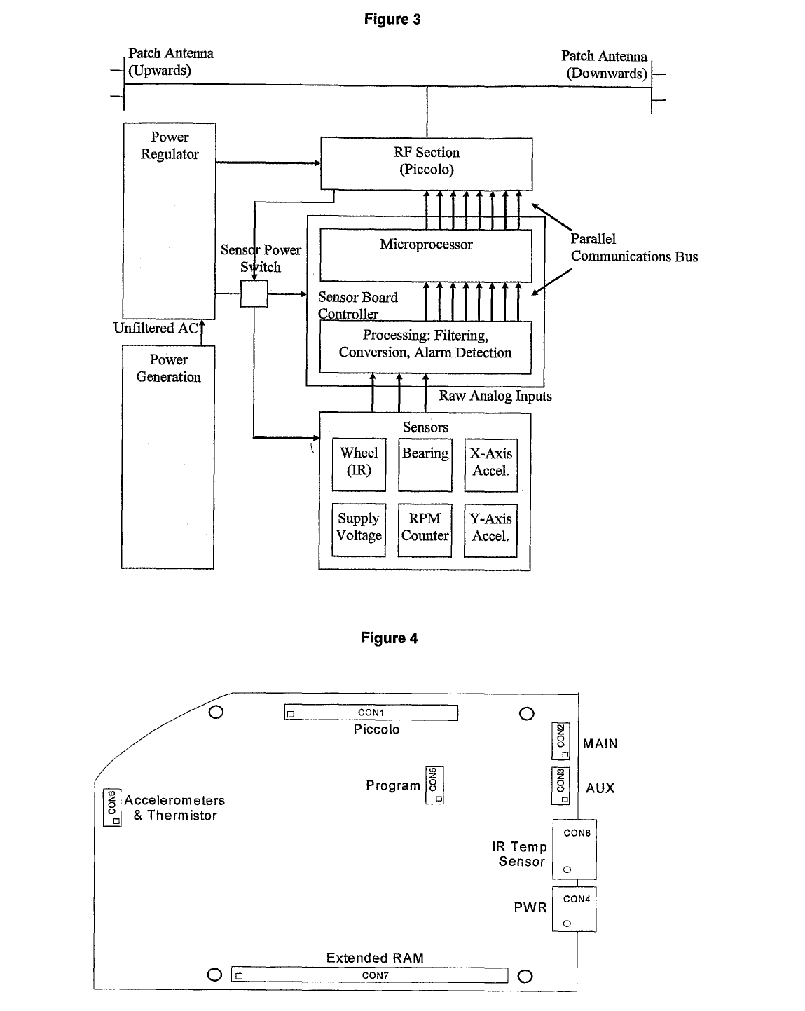

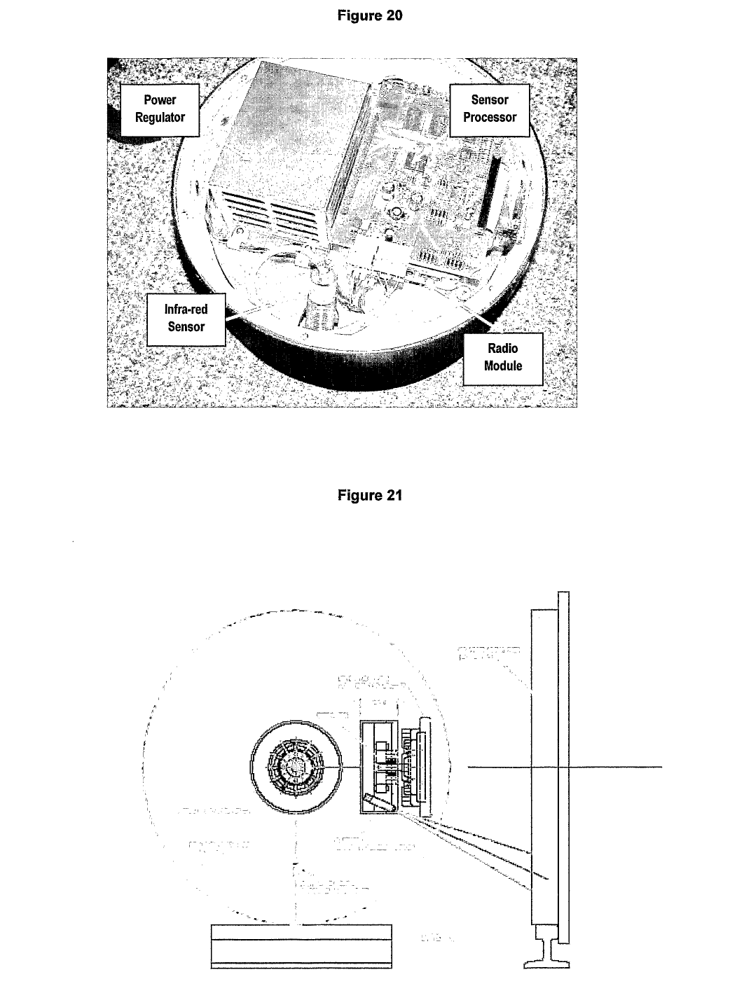

FIGS. 19 and 20 show a schematic and a photographic view respectively of the bogie units while FIGS. 3 and 4 illustrate their architecture and sensor circuit board layout respectively. The power required for each unit is generated by a multiphase AC alternator in which the stator is the coil assembly and the magnets are fixed to a circular disc that spins at wheel velocity. The multiphase AC output is proportional to wheel velocity (within certain constraints) and is rectified, regulated and processed by a regulator module.

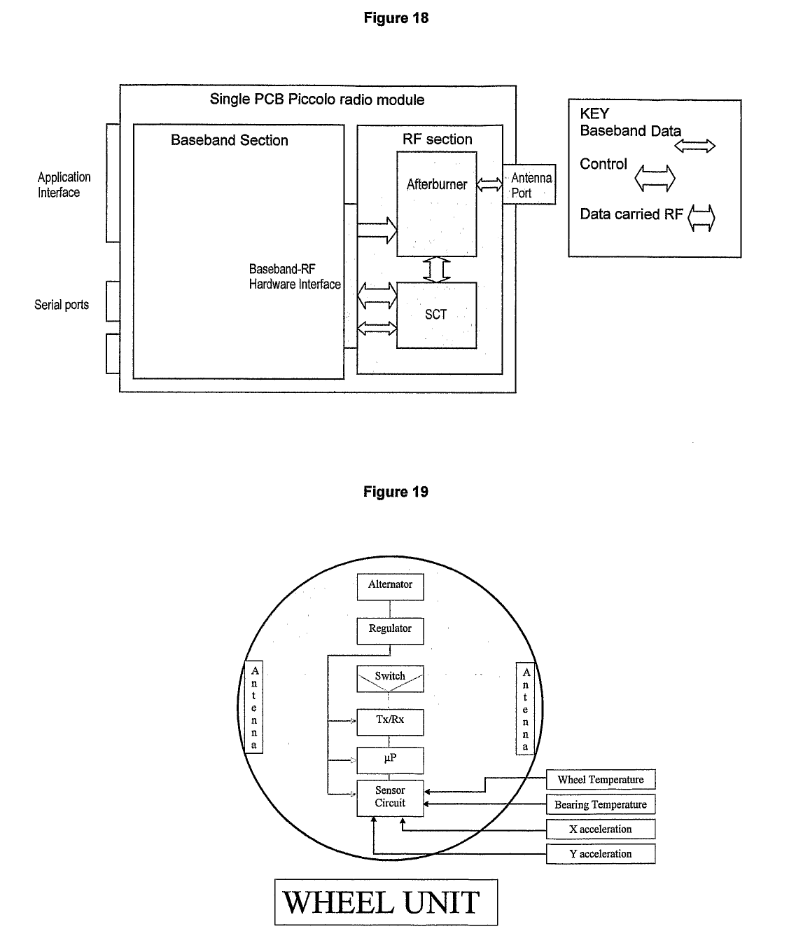

The power regulator supplies power to a single Piccolo radio module PCB shown in FIG. 18, the sensor circuit board as shown in FIG. 4, and the sensors; the Piccolo module is powered directly but the other components are only supplied with power when the Piccolo has become active and enables the sensor power switch. The sensor power switch is only activated when the Piccolo has determined that there is sufficient power from the bogie units to supply the sensor sub-system; this is done my monitoring the raw voltage output of the power supply regulator circuit.

There are two temperature sensors, one for sensing the temperature of the hub of the wheel, and hence the inferred bearing temperature, and the other for measuring the temperature at the periphery of the wheel by infrared means as shown in FIG. 21. The outputs of the sensors are analog DC voltages proportional to temperature and are converted to digital signals via an analog to digital converter (ADC). These signals are then converted to degrees C, low-pass filtered, and compared against alarm triggering levels. If the filtered temperature exceeds the prescribed alarm level an alarm is triggered and is not cleared until the temperature falls below a second prescribed level, thus providing hysteresis.

Vibrations in the vertical and horizontal planes of the wheel are measured by two orthogonally mounted accelerometers. The accelerometer outputs are analog DC proportional to acceleration between defined limits. These outputs are converted to digital via an ADC, converted from ADC units (voltage) into real-world units (G's), low-pass filtered, and compared against an alarm level. If the filtered acceleration exceeds the prescribed alarm level, then an alarm is generated. Approximate wheel velocity is derived from the power generator supply voltage which is divided down and converted to digital via an ADC. The result is then converted into a voltage which is proportional to rate of rotation. However precise wheel velocity is determined by a Hall Effect device attached to the rotating magnet assembly which produces a pulse output for each completed wheel revolution.

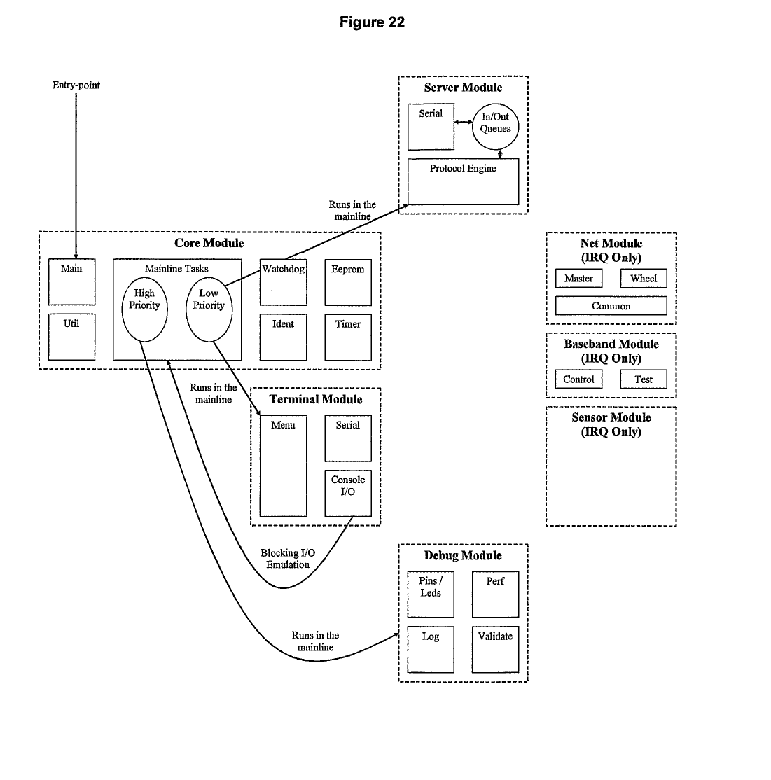

The microprocessor module of the bogie units uses high speed programmable logic arrays to process the incoming data from the sensors described above so that it is not overloaded with tasks which reduce its response time and limit its ability to control the RF section. A flow diagram of the programming software for the units is given in FIG. 22. Communication between the processing module and the microprocessor module is via a parallel bus which enables the fastest communications possible. This module performs the following functions:
Processing alarms generated by the module and activating the data radio.
Providing instructions to the processing module.
Providing non-volatile storage of temperature and vibration data for continuous transmission in the event of a valid alarm condition.
Managing a serial data protocol for external communications and programming.
Establishing routines for “heartbeat” responses
Managing the data radio background functions.
Managing store and forward functionality and redundancy.

A high speed digital radio which has its power and antenna outputs controlled by the microprocessor module is used to transmit to and receive from other bogie units and the server. The radio performs dual roles of a network repeater or an end point station depending on the network configuration and its position in the train consist. The antenna system is designed to focus the RF energy forward and backward along the axis of the train so that other units will be radiated by the RF lobe maxima. The range of the signal is controlled by the power output of the transmitter which is in turn controlled by the microprocessor. Spectrum reuse is paramount in a very long consist and so the range of the units' data radio has to be controlled.

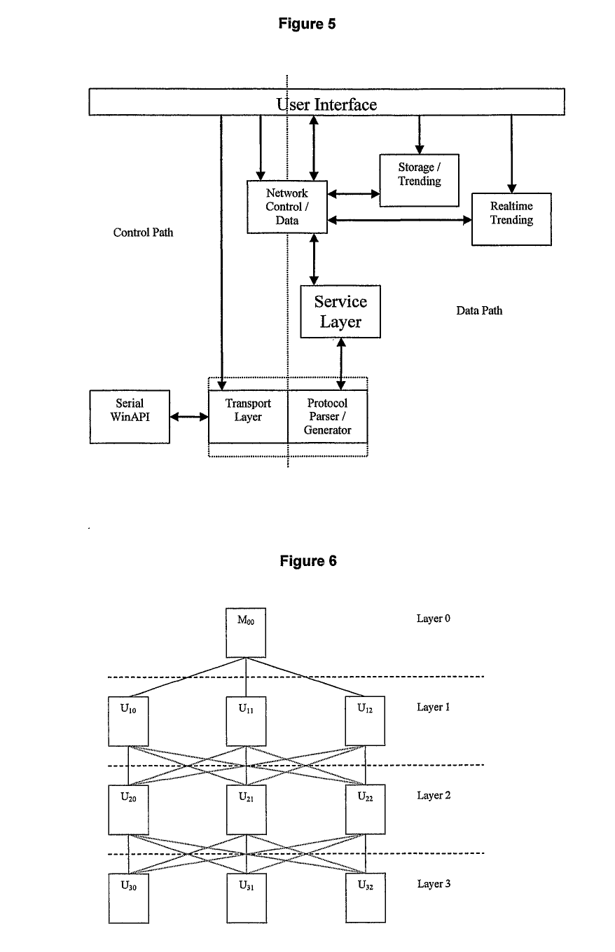

FIG. 5 is a schematic of the six components of the server namely a network protocol parser and generator, a service layer, an automatic network control and data gathering, real time trending, data storage and trending and a user interface. The protocol generator and parser generates request packets for the data radio and parses response packets for the service layer to interpret. The service layer provides individual status of the wheel with alarm reporting, individual status of the wheel without alarm reporting, and network status and alarm reporting on the entire network.

The automatic network control and data gathering performs automatic status retrieval from bogie units on the network, alarm generation from status retrieved, individual monitoring of units and interface to real-time graphical trending. The latter also displays data graphically as it arrives in the automatic network control and data gathering component and visually indicates alarm conditions. The data storage and trending includes a database with the option to graph the time stamped data stored and to apply algorithms to it. Connection from the server to the bogie units is via a data radio and the server can be connected to an external wireless network such as a satellite data modem or a WLAN or any standard data radio in order to report to a remote management centre.

The TINS wireless network architecture is shown in FIG. 6 as a series of interconnected units arranged in layers having a depth of four units and a width of three units. The depth of a network is the maximum number of units that a message must travel through in order for it to move between the master and the furthest unit and the width is the maximum number of units in each layer.

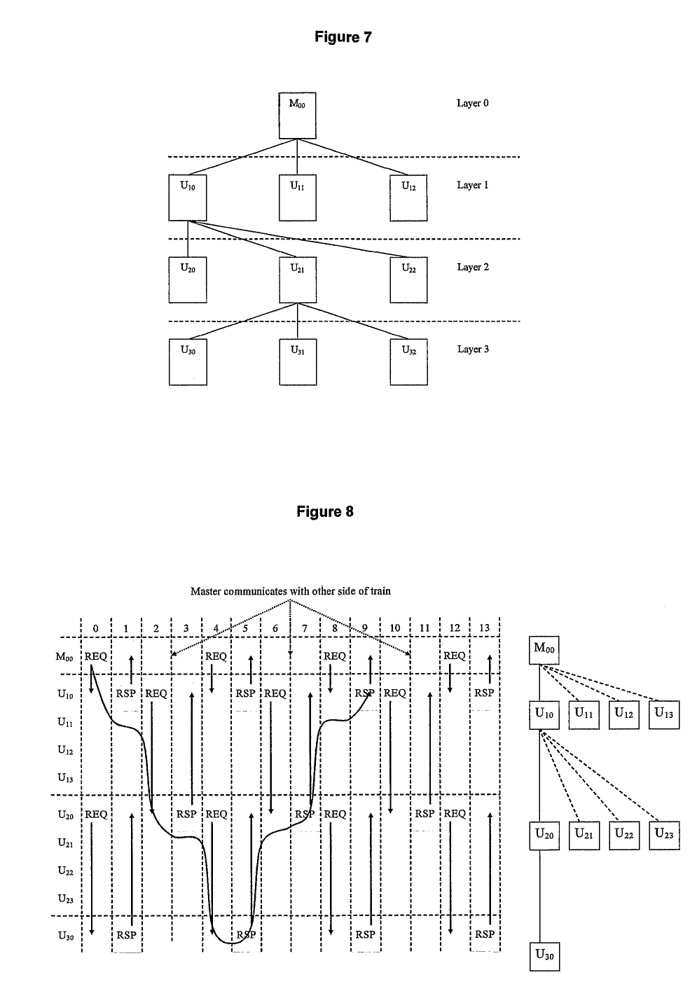

The network can be in one of two modes, an establishment mode or an operational mode. In the former one unit from each layer is designated as the primary and only that unit can transmit messages to or receive messages from units below it in the network as shown in FIG. 6. In the latter mode any units in layer n can communicate with units in layers n+1 and n−1. In this scenario each unit communicates with a single unit in the lower layer, and a single unit the upper layer, effectively creating a number of different networks equal to the network width. A unit may communicate with more than one unit in the layer above or below it and in the network establishment mode shown in FIG. 7, only M₀₀, U₁₀, U₂₁, and U₃₀ can transmit messages to units in lower layers or receive messages from units in lower layers. A maximum of 6 units per layer is supported within the network.

The TINS wireless network also uses a time division store and forward communications architecture with multiple redundant communication paths while in full operation. All data is transmitted in fixed width slots and any one slot may contain one or two frames depending on the format of the slot. There are three types of slots downlink, uplink and connect. A downlink slot contains data to be transmitted from the master to a single unit or to all units. Data transmitted in a downlink slot is not acknowledged by receiving units within the same downlink slot. Downlink slots are used to transmit data down the communications network. An uplink slot contains data to be transmitted from a single unit to the master. Data transmitted in an uplink slot is acknowledged by the receiving unit within the slot. Uplink slots are used to transmit data up the communications network. A connect slot allows unconnected units to announce themselves and permit connection to the network.

Accordingly there are two distinct communications behaviours in the TINS wireless network. When the network establishment mode is entered during start-up the set of available units is discovered, and the role of each unit in normal operation is allocated. While undertaking network establishment, there is no redundancy and a unit failure will result in the restarting of network establishment. Once the network has been established, the operational mode is entered and the network supports multiple redundant communication paths. In this mode the network performs the following functions. The units asynchronously report alarm conditions to the master; the alarms are propagated from the generating unit to the master via the communications network. The stati of the sensors on a single unit are reported to the master in real-time; the last ten minutes of data for the internal sensors is also transmitted to the master when this function is operating. The units also pass on debugging information.

In the following description of the TINS network, when a unit A is above unit B there are fewer hops between the master and unit A than between the master and unit B. And when unit A is below unit B, then there are more hops between the master and unit A, than between the master and unit B. Each unit in the TINS network has three pre-configured addresses, and one dynamically allocated address. The three pre-configured addresses are:
Globally Unique Identifier (GUID): A 32-bit factory configured address.
Carriage Identifier (CID): A 25-bit user configured address. All wheel units on the same carriage must have the same carriage address.
Wheel Number: A 3-bit user configured address. This indicates which wheel on the carriage a particular unit relates to. The wheel numbering can be found in the PRS.

The wheel number of carriage identifier go together to form a 32-bit Carriage Unique Identifier (CUID). The dynamically assigned address is the Dynamically Allocated Hopping Pattern (DAHP). The DAHP sets the frequencies that the unit transmits and receives on, and uniquely identifies the unit in the network.

In the following sections a number of symbols are used to represent various network configuration and timing parameters. These are shown below.
d The depth of the network.
w The maximum width of the network.
bₘ The number of bytes in a monitoring upload slot.
m The amount of bandwidth (in bits per second) available for monitoring.
nc The number of channels.
nᵤ The number of uplink slots per downlink slot used in normal operation.
tₑ(x) The amount of time (in seconds) required to complete a request or response cycle during network establishment for a network of depth x.
t_{d}(x) The amount of time (in seconds) required to complete a single discovery cycle on a network of depth x.
t_{down}(x) The amount of time (in seconds) required for a message to propagate from the master to a unit at depth x. This is only applicable in normal operation.
tᵤₚ(x) The amount of time (in seconds) required for a message to propagate from a unit at depth x to the master. This is only applicable in normal operation.
tₓ(x) The amount of time (in seconds) required to complete a single network extension on a network of depth x.

tₗ The total time taken to achieve lock.
tₙ The total amount of time (in seconds) required to complete network establishment.
tₛ The slot time in seconds.
r The number of transmissions required to successfully receive a data frame. For example, r=1 implies that 100% of packets get through on the first attempt, with r=1.5 implies that 50% of packets get through on the first attempt.
s_{d} The number of slots to spend performing network discovery.

When a unit first powers up in network establishment mode it enters the unconnected state and behaves as follows. It listens on a single channel for (n_{c}+1)tₛ ms, where n_{c} is the number of channels and tₛ is the maximum slot time. After this time it moves to the next channel and continue listening. If a downlink frame is detected it checks the child address list for this unit's GUID. If it is found it then locks and hops with that unit. If a connect frame is detected, it locks and hops with that unit until the connect frames stop being transmitted and generates connect responses occasionally until acknowledged.

Network establishment is controlled by the master unit in the locomotive and the TINS network operates in a simple request/response mode as shown in FIG. 8. Requests are generated by the master, and each unit continually retransmits the same request until the master changes the request it is transmitting. Each request is directed to a single unit. Once the unit has completed the request, it passes a response back to the master via the network.

In FIG. 8 a request is inserted in slot 0 and propagated down to U₃₀, where a response is generated which returns to the master in slot 9. The master spends half of its time talking to one side of the train as shown and the other half of its slots are used to communicate with the other side of the train. Lost requests are handled by the downlink constantly sending the same message until the master changes it. This will not happen until a response is received or a timeout occurs. Lost responses are handled by retries within the uplink frame.

When using this scheme, the amount of time required to transmit a request from the master to its destination, or from a unit to the master is given by:

tₑ(x)=tₛ[2r(x−1)]

where x is the depth of the unit. All master generated requests have an associated timeout period. If a response is not received before the timeout expires then the transmitted request is considered lost. This causes the restart of network establishment which has two basic operations, network discovery where a single unit is instructed by the master to discover what other to discover what other unconnected units are available for communications and network extension where a single unit is instructed to extend the communications network.

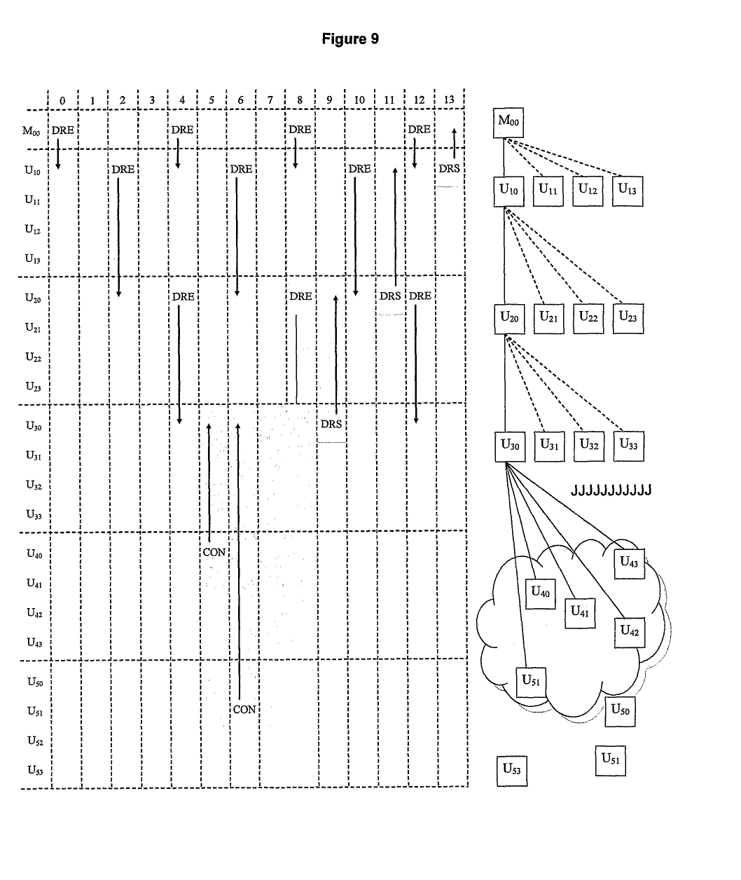

The messages used to perform network discovery are shown in FIG. 9 where a DISCOVER-REQ message is transmitted from the master, and propagated down to a single destination. When the destination of the DISCOVER-REQ message receives it, the unit enters discovery mode and allows all unconnected units to transmit CONNECT messages. The connect message contains the following information: the GUID and the CUID of the transmitter, the RSSI between the connected and unconnected units and the number of failed connect attempts. Each CONNECT message is acknowledged by the connected unit. Once an unconnected unit has been acknowledged, it no longer attempts to transmit. The number of slots available for unconnected units to transmit is broadcast by the connected unit. The time taken for an unlocked unit to achieve lock with a unit that is transmitting CONNECT messages is given by:

tₗ=r(n_{c}+1)tₛ

Thus, the number of slots allocated to locking must take into account this period of potential dead-time at the start.

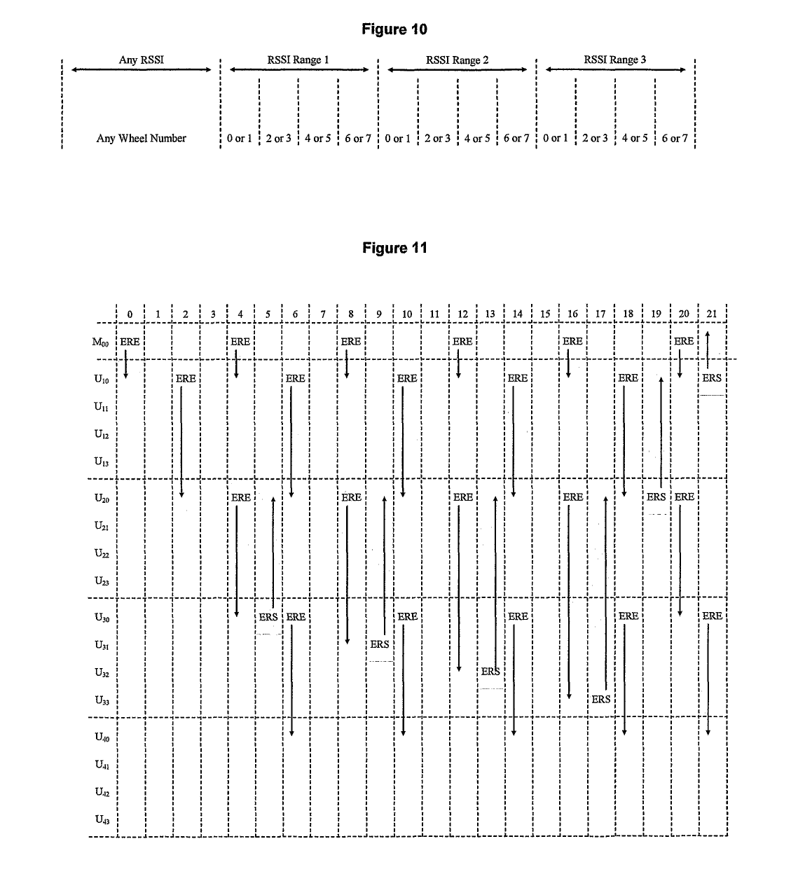

The parameters for received signal strength intensity (RSSI) and wheel number are available for controlling unconnected unit transmissions to minimise the possibility of collision. During the first phase of connection there is no restriction, however during the second phase the air time is divided such that RSSI and wheel number select the slots that unconnected units may transmit as shown in FIG. 10.

Network extension occurs after network discovery and is used to extend the network by adding an additional layer. The messages used for network extension are shown in FIG. 11 If network discovery is performed by U₃₀, then the network extension command will be passed to U₂₀. It is then the responsibility of U₂₀ to pass the network extension command to all its children (U₃₀ through U₃₃) and verify that each one received the command. The network extension request contains the following information: the DAHP for each unit in the layer below the destination, the children of each unit the layer below the destination and the primary for each child of the layer below the destination. When using this scheme, the amount of time required to perform network extension for a single layer at depth x is given by:

tₓ(x)=2tₑ(x)+4r.w.tₛ

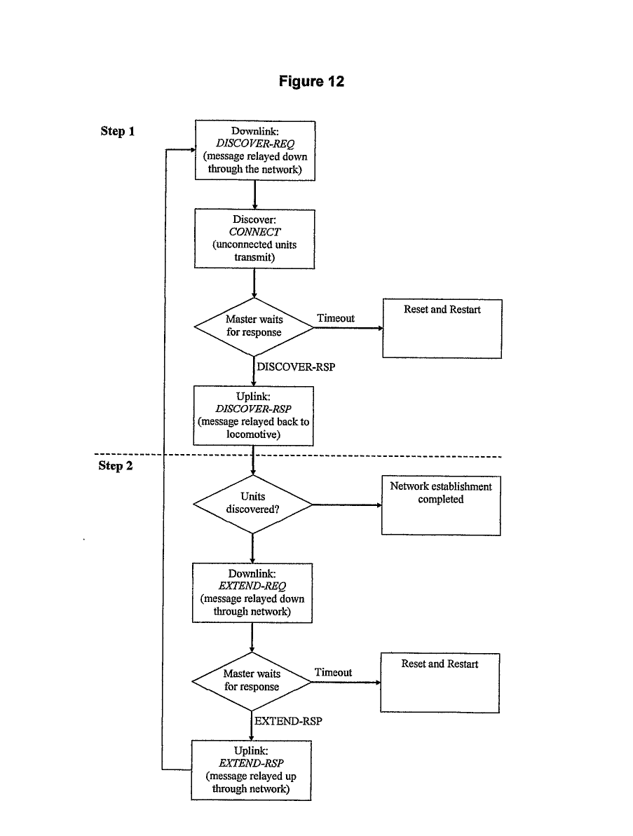

The flowchart for network establishment is shown in FIG. 12 as a repetitive two step process. In the first step the available units are discovered, while in the second step the network is extended to accept these new units. This process is repeated until no new units are discovered. Network establishment is O(d²) in complexity. The total time required to perform network establishment is given by:

$$\begin{matrix}{t}_{n} = {\sum }_{x = 1}^{d} ( {t}_{d} ( x ) + {t}_{x} ( x ) ) \\ = {\sum }_{x = 1}^{d} ( 2 {t}_{e} ( x ) + {t}_{s} {s}_{d} + 2 {t}_{e} ( x ) + 4 {t}_{s} rw ) \\ = {\sum }_{x = 1}^{d} 4 {t}_{e} ( x ) + ( {ds}_{d} + 4 drw ) {t}_{s} \\ = {\sum }_{x = 1}^{d} 4 {t}_{s} [ 2 r ( x - 1 ) ] + ( {ds}_{d} + 4 drw ) {t}_{s} \\ = 8 {t}_{s} r {\sum }_{x = 1}^{d} x - 8 {t}_{s} r + ( {ds}_{d} + 4 drw ) {t}_{s} \\ = 4 {t}_{s} r ( {d}^{2} + d ) - 8 {t}_{s} r + ( {ds}_{d} + 4 drw ) {t}_{s} \\ = {t}_{s} ( 4 r {d}^{2} + 4 r d - 8 r + {ds}_{d} + 4 drw )\end{matrix}$$

The US Federal Communications Commission's regulations (Part 15.247) for frequency hopping systems in 2.4 GHz state:
(1) Frequency hopping systems shall have hopping channel carrier frequencies separated by a minimum of 25 kHz or the 20 dB bandwidth of the hopping channel, whichever is greater. The system shall hop to channel frequencies that are selected at the system hopping rate from a pseudo randomly ordered list of hopping frequencies. Each frequency must be used equally on the average by each transmitter. The system receivers shall have input bandwidths that match the hopping channel bandwidths of their corresponding transmitters and shall shift frequencies in synchronization with the transmitted signals.

And:
(ii) Frequency hopping systems operating in the 2400-2483.5 MHz and 5725-5850 MHz bands shall use at least 75 hopping frequencies. The maximum 20 dB bandwidth of the hopping channel is 1 MHz. The average time of occupancy on any frequency shall not be greater than 0.4 seconds within a 30 second period.

The major feature of these requirements is that on average, each frequency must be used with the same regularity and the occupancy of any frequency must not be greater than 0.4 seconds in any 30 second period. The wheel units use a set of 256 unique hopping patterns. All hopping patterns are of a fixed length equal to the number of available channels, where each channel is visited exactly once. Hopping pattern position is derived from the master, thus each unit in the network visits the first channel in its hopping pattern at the same time. Based on these properties, hopping patterns can be selected that minimize interference.

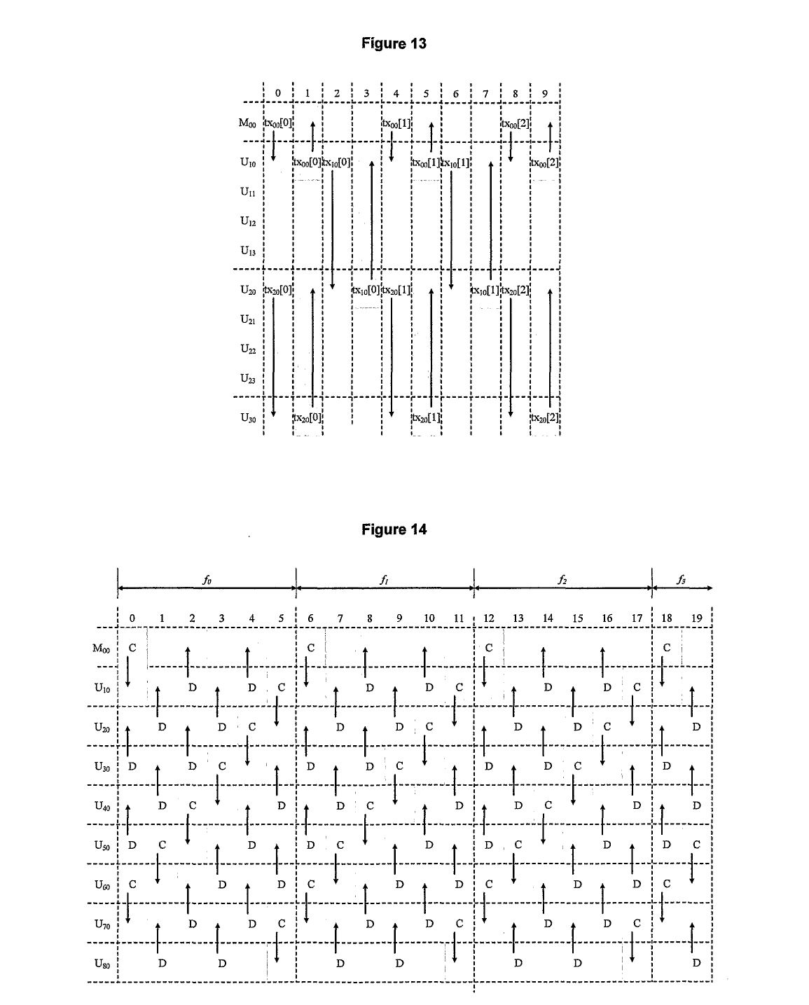

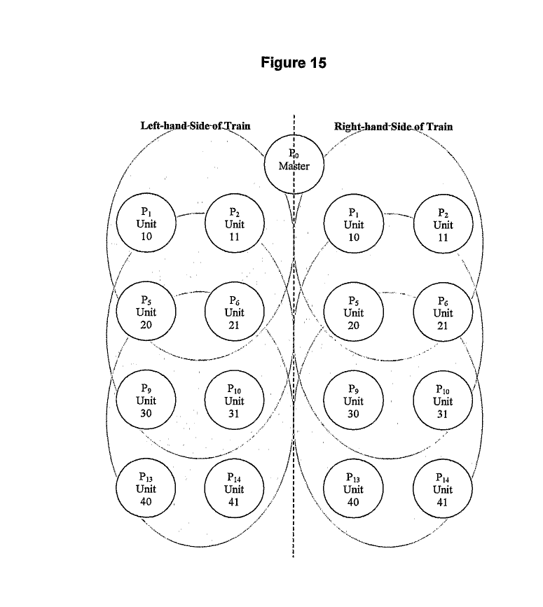

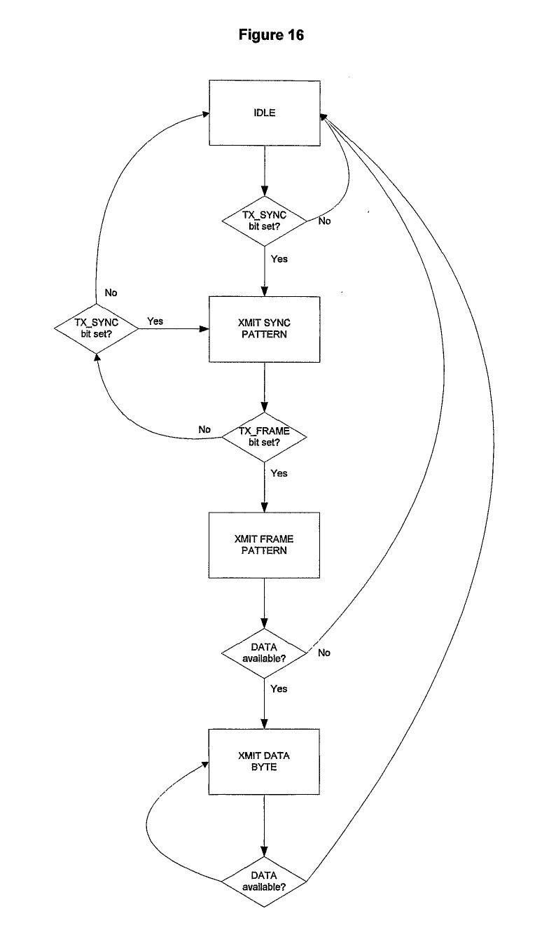

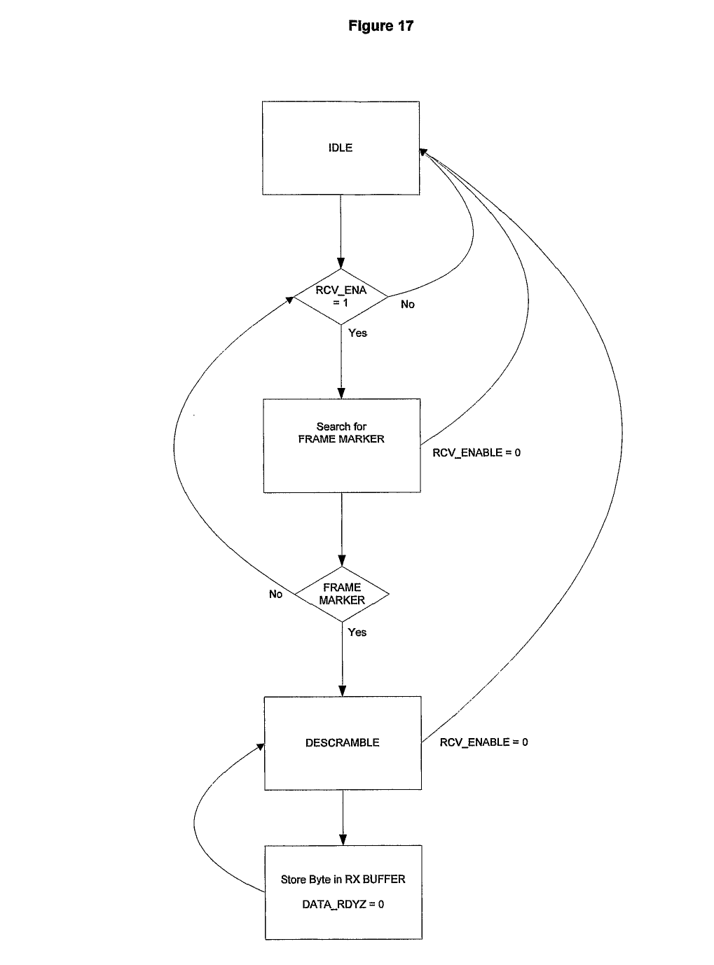

The allocation of frequencies during network establishment shown in FIG. 13 is unbiased ie no favour is given to any particular frequency, nor is any particular frequency used for a particular purpose. Each transmitter effectively uses two hopping patterns equally, its own and the hopping pattern of the unit above. Thus, on average each frequency is used with the same regularity by each transmitter as both hopping patterns contain all frequencies. The hopping pattern progresses by 1 each time the master transmits a downlink slot. The connect slots use the hopping patterns by progressing the hopping pattern index by one on each slot. When in operational mode as shown in FIG. 14, a change in frequency (progression through the hopping pattern) occurs with each control frame the hopping channel index increases by 1 for each control frame.

The downlink frame contains two parameters used to control hopping pattern progression: the offset number which is the number of slots that the transmitters downlink frame transmission is offset from the master's downlink frame transmission and the current hopping pattern index number which gives the transmit frequency.

Hopping patterns can be calculated for minimum interference by using the following properties of the network:
Units are arranged in layers, where any unit in layer n can hear units in layer n+1 and n−1. We will also assume that it is possible to hear units in layers n+p and n−p, where p is the RF propagation factor.
Units on either side of the train cannot hear each other.
Each unit visits the same index in a hopping pattern at the same time.

Thus, the following rules apply to the hopping patterns: 256 hopping patterns must be generated and no set of w(2p+1) sequential hopping patterns have a collision in any channel. The TINS hopping pattern sequences are calculated using a linear congruent generator (LCG) of the form:

yₙ₊₁=(ayₙ+b)mod m

The minimum standard (MINSTD) generator is used, having constants:

m=2³¹−1=2147483647

a=7⁵=16807

b=0

The result of the LCG is to pick one of the remaining frequencies for each hopping pattern, where frequencies that would interfere are not allowed to be selected.

Accordingly the TINS provides real time monitoring of critical factors and impact risk assessment of failure immediately and not at some future time or distant monitoring wayside station. There exists an immediate option for the driver to decide whether to stop the train, reduce speed till the defective wagon can be removed form the consist or take other action. All the while real time monitoring of the alarm condition is displayed to the driver including the last ten minutes of operation since the condition occurred. A decision can be made on the validity of the alarm, the event that may have caused the alarm and therefore the expected risk of continuing.

The TINS system also provides an end-of-train monitoring system via the bogie units of the last wagon without the need for additional equipment and is independent of the length of the train or the effect of tunnels or terrain, unlike existing wireless end-of-train systems. By installing train simulation software (TSS) into the TINS server the compressive or tension condition across each coupling along the length of the train can also be monitored. This feature enables the driver to better manage train dynamics as well as run in and run out. By integrating a GPS unit the TINS network offers additional anti-collision features between the end of the train and a following locomotive entering a proximity envelope.

By installing ACS data common protocol (DCPS) transponders, interface and software in the server, the TINS system also provides an effective low cost anti-collision system. When any two trains fall within the ACS footprint operating range, which will depend on terrain but is generally a five kilometre separation, the server will draw the driver's attention to the interaction of the approaching trains. This range can be extended as required at specific locations by the installation of permanent wayside repeaters.

The display on the locomotive server will show the relative velocity of each train, the distance of separation to a one metre resolution, a spatial map showing the position of and proximity to track infrastructure, including which track each trains occupies, which determines the risk of collision. This information will give drivers sufficient warning to react immediately or to contact a traffic controller for instructions. Accordingly, following train movements can be kept at a minimum separation regardless of visibility and cruise control options with locomotive throttle mechanisms also become possible.

By installing a database of GPS positions of all road/rail crossings on the rail system and installing a transponder at each crossing, a crossing warning system can also be incorporated into the TINS. A radio broadcast is made continuously identifying the crossing with its code name with the broadcast range varied by the power of the radio system. With optimum antenna configuration and design, a range at maximum power of 2.5 kilometres is achievable. When the proximity switching system installed at a road crossing senses that the crossing is, or is about to be obstructed by a vehicle or person, or in the case of an actively protected crossing the boom gates or bells are functioning, but fouled by traffic or people, the video system is activated. A real time video capture of the crossing is broadcast over the 2.5 kilometre range of the system.

When a train enters the 2.5 km crossing footprint or greater footprint if repeaters are installed, the crossing ID is recognised, tested for functionality and logged as such in the server database. Crossings not functioning are reported at specific reporting points along the route or can be reported online with satellite communications separately installed. The video capture of the crossing is stored in the server until the train has cleared the crossing. Accordingly, the driver is able to ascertain any risk prior to reaching the crossing and to take appropriate action. In the event that the time to stop the train is inadequate the system provides the train operator with a clear record of the responsible party to the accident.

If no proximity switches are activated, the crossing is logged in the database as being functional but no image is displayed to the locomotive driver. A record of events is collected and stored whilst the train itself intercepts the crossing. In the case of multiple crossings, the imagery is stacked sequentially based on the closest first. Where an accident occurs, the video capture will record the events creating the accident, whether the cause of the track being fouled was before the arrival of the locomotive or after, in the case of a crash into the side of the train. The video capture is terminated once the train clears the crossing and if no interjection is made by the driver as a vigilance procedure the record is removed from the storage device for the particular crossing. This system is also able to transmit a warning signal to vehicles approaching a level crossing which are equipped to receive the signal and so reduces the train whistle objections raised by local residents.

The surplus power generated by the bogie units whilst the train is in motion is used to operate strobe lighting on units thus illuminating the full length of the train and improving its visibility side on. When the train is stationary the strobe lighting ceases and the bogie units go into hibernation mode.

### Variations

It will be realized that the foregoing has been given by way of illustrative example only and that all other modifications and variations as would be apparent to persons skilled in the art are deemed to fall within the broad scope and ambit of the invention as herein set forth. In particular it will be apparent that the TINS could be applied to vehicular systems other than trains and systems which have characteristics similar to trains such as security monitoring systems.

Throughout the description and claims to this specification the word “comprise” and variations of that word such as “comprises” and “comprising” are not intended to exclude other additives, components, integers or steps.

1. A train integrity network system comprising two or more bogie units which monitor critical parameters relating to the condition of bogie components and the rail track they are travelling on, an onboard server which controls the bogie units and a wireless network which enables communication between the server and the bogie units.

2. The system of claim 1 wherein the bogie units have sensors to monitor the temperature of the hub of a bogie wheel.

3. The system of claim 1 wherein the bogie units have sensors to monitor the temperature of the periphery of a bogie wheel.

4. The system of claim 1 wherein the bogie units have motion detectors to monitor movement of the bogie axle in vertical and horizontal directions.

5. The system of claim 1 wherein the bogie units have accelerometers to monitor acceleration of the bogie axle.

6. The system of claim 1 wherein the bogie units have means to measure the speed of rotation of a bogie wheel.

7. The system of claim 1 wherein the bogie units are powered by an electrical generator which utilises the rotation of the bogie wheels.

8. The system of claim 1 wherein the bogie units have a processor which compares the critical parameters against defined standards.

9. The system of claim 1 wherein the bogie units have a wireless transceiver which enables communication with other bogie units and the server.

10. The system of claim 1 wherein the bogie units have a source of illumination.

11. The system of claim 1 wherein the wireless network utilises master/slave base band role switching.

12. The system of claim 1 wherein the wireless network has store-and-forward nodes which convey quasi real time data to the server.

13. The system of claim 1 wherein the wireless network utilises frequency hopping modes.

14. The system of claim 1 wherein the server can download data to a wayside database.

15. The system of claim 1 which also has a GPS unit to record the location of the train at any time.

16. The system of claim 1 which has an end-of-train monitoring function.

17. The system of claim 1 which has a collision avoidance function.

18. The system of claim 1 which has a level crossing warning function.

19. The system of claim 1 which transmits a warning signal to vehicles approaching a level crossing which are equipped to receive said signal.

20. The system of claim 1 which monitors tension and compression in the train wagon couplings.
